(19) United States
(12) Patent Application Publication
(10) Pub. No.: US 2018/0329495 A1
(43) Pub. Date: Nov. 15, 2018

(54) NOTIFICATIONS IN A WEARABLE DEVICE

(71) Applicant: Hewlett-Packard Development Company, L.P., Houston, TX (US)

(72) Inventors: Murilo Juchem, Vancouver, WA (US); MIchael W Hu, Vancouver, WA (US); Greg Martin, Portland, OR (US); Noah DiJulio, Portland, OR (US)

(73) Assignee: Hewlett-Packard Development Company, L.P., Houston, TX (US)

(21) Appl. No.: 15/772,223

(22) PCT Filed: Feb. 24, 2016
(86) PCT No.: PCT/US2016/019226

§ 371 Date: Apr. 30, 2018

(51) Int. Cl. G06F 3/01; G06F 1/16

(52) U.S. Cl. CPC G06F 3/016; G06F 1/163

(57) ABSTRACT

An example method, for providing notifications in a wearable device, is disclosed. The method includes identifying an event, determining a category associated with the event, providing a first notification for the event based on the category, and providing a second notification for the event based on the category. The first notification includes a haptic pattern, and the second notification includes a lighting pattern.

### BACKGROUND

Mobile computing devices can perform a variety of functions and execute a variety of applications, similar to a traditional computing system. Mobile computing devices can be carried or worn, sometimes on the wrist of a user in a manner similar to a traditional watch. Mobile computing devices that are worn on the wrist of a user can be known as smart watches. The function or application to be executed by the smart watch can be chosen by the user by selecting the application or function from a display on the smart watch. The display is sometimes located where a traditional watch face would be. The display represents any screen used to provide information visually and, comprise LED, OLED, digitally controlled watch hands and/or alike.

### BRIEF DESCRIPTION OF THE DRAWINGS

For a detailed description of various examples, reference will now be made to the accompanying drawings in which:

FIG. 1 is a block diagram of an example system accordance with the principles disclosed herein;

FIG. 2 is an example table defining events and notifications of the system of FIG. 1 in accordance with the principles disclosed herein;

FIG. 3 is an example defining haptic patterns of the system of FIG. 1 in accordance with the principles disclosed herein;

FIG. 4 is an example defining lighting patterns of the system of FIG. 1 in accordance with the principles disclosed herein;

FIG. 5 is an example defining priority settings of the system of FIG. 1 in accordance with the principles disclosed herein; and

FIG. 6 is a flowchart of an example method executable by a system of FIG. 1 in accordance with the principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection. As used herein the term “approximately” means plus or minus 10%. In addition, as used herein, the phrase “user input device” refers to any suitable device for providing an input, by a user, into an electrical system such as, for example, a mouse, keyboard, a hand (or any finger thereof), a stylus, a pointing device, etc.

### DETAILED DESCRIPTION

The following discussion is directed to various examples of the disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example.

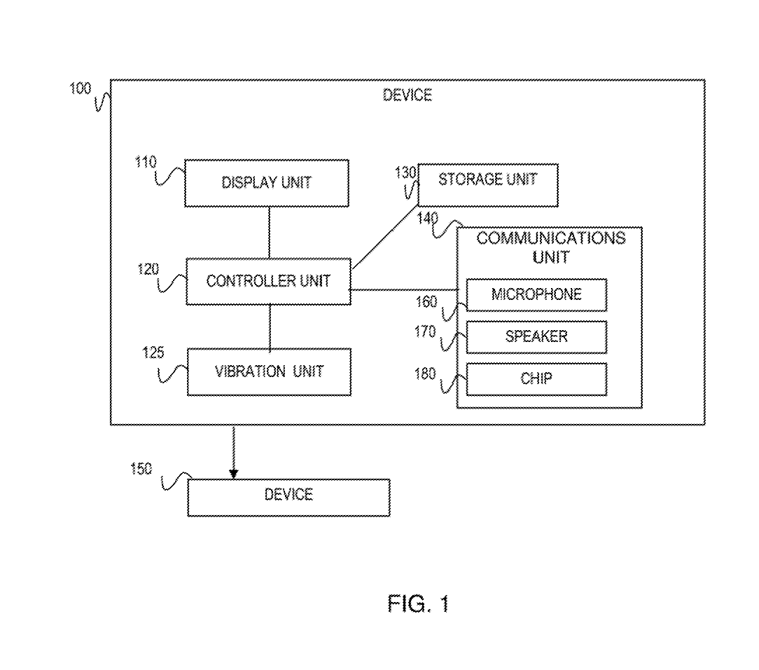

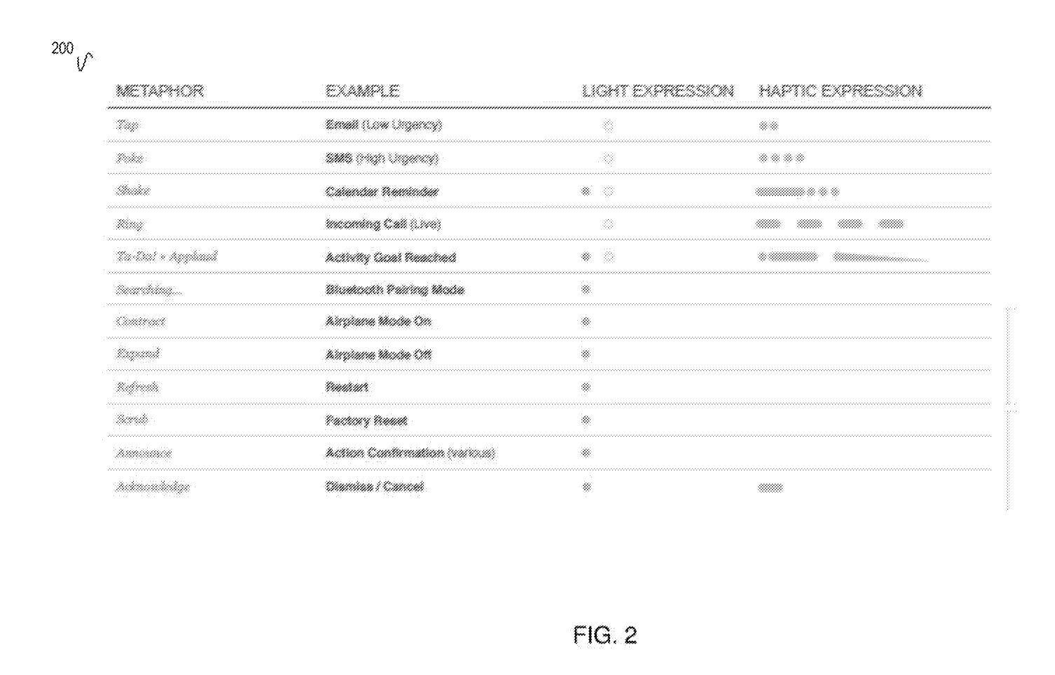

Referring now to FIG. 1, a wearable device 100 in accordance with the principles disclosed herein is shown. In this example, the wearable device has been shown as an electronic watch. It should be noted that other example may comprise different types of watches or different types of wearables devices. The device 100 comprises a display unit 110, a control unit 120, a storage unit 130 and a communications unit 140. The device 100 allows a user to send and receive messages, such as email messages, text messages, audio messages and/or digital images and/or perform other functions currently confined to computers and smart phones. In this implementation, these functions may be called events. For example, a new email event refers to the device's function of receiving a new email, or a new call refers to the device's function of receiving a new call. Further, each event may have a notification associated with it. Accordingly, when the event takes place, the device 100 uses the notification to alert the user of the event. Such notification may comprise a haptic pattern, a lighting pattern and/or information provided on the display. Further, such notification may be grouped in various categories, wherein the categories may be defined based on a criteria such as urgency (e.g., low urgency, medium urgency and high urgency), contact (e.g., family, friends, co-workers, and unknown) and notification source including data feeds that are received by the device from a data source such as news headlines, sports scores, and real-time information delivered to the device such as weather conditions, social network posts, etc., delivered through another device (150). This will be discussed in more detail in reference to FIGS. 2-5.

The display unit 110 is for displaying time, day, date and related information, and displays time, day, and date information, as well as various icons to enable users to send and receive the messages and/or perform the functions with ease. In some other examples, the device 100 may include a mechanism other than a display to convey information to the user. For example, the display unit 110 can be a collection of LED lights that don't allow for icons. In another example, the device 100 may be an analog device, such as an analog watch, where some of the hands of the watch are digitally controlled to provide information.

A plurality of watch control means (not shown) by which the user can adjust the time, day, date and related information are also included on the display unit 110, as well as a power button for turning on and off the device 100. The display unit may be a transparent liquid crystal display (LCD), an organic light emitting diode (OLED) display, a plasma display, or any other suitable display, including but not limited to a collection of LEO lights or smart hands (in case of a watch) controlled digitally. In one example, the display unit 110 may be touch sensitive, and the user can use touch gestures to interact with the device 100. The display unit 110 may receive haptic input. For example, tactile signals (e.g., finger movements) may be mapped into characters or symbols recognizable as a communication language. In another implementation, the display 110 may display various lighting notifications, notifying the user of a certain event. This provides an update to the user of various events and event details without the need to access another device that the device 110 may be connected to. For example, when the user receives a new email, the user may find out about this update through the device 100, without the need to access another device (e.g., device 150). This event of new email is considered low urgency, and accordingly is grouped into the low urgency category. The display 110 may display the notification associated with low urgency category, which is displaying a pulsing dot between 35% and 100% in time. Such notification may be repeated three times or until dismissed by the user. This will be discussed in more detail in reference to FIGS. 2-5.

The device 100 includes the controller unit 120 for managing operations of the device 100 (and in some examples, operations of the other devices the device 100 may be connected to). The controller unit 120 contains a processor for allowing a user to not only send and receive, email messages, text messages, audio messages, and/or digital images, but also to check email, check social networking sites, manage daily schedules and complete other functions that the user would do with computers and smart phones.

In one implementation, haptic feedback may be incorporated into the device 100, and the device may provide output via haptic language through the vibration unit 125. More specifically, the device may provide additional contextual information to the user based on haptics alone, providing various alerts by way of vibrations. Such haptic information may come in the form of notifications in response to certain events that may be detected by the device 100. For example, when the user receives a new email, the device can alert a user to an incoming email by vibrating. In one example, the device 100 may vibrate twice for two seconds. In other examples, similarly, the device 100 can alert the user to a scheduled calendar item or provide a user with a reminder for a “to do” list item or calendar appointment. Further, haptic effects can be used to simulate “real world” dynamic events, such as the feel of a bouncing ball in a video. This haptic patters for different events may be included in the device's settings or may be set by the user.

Further, the haptic patterns may be determined based on the category the event falls under. As mentioned earlier, events are grouped into categories defined based on a criteria such as urgency (e.g., low urgency, medium urgency and high urgency) or contact (e.g., family, friends, co-workers, and unknown). These categories act as priority settings. For example, a new email from a friend may be considered low urgency, and a new email from a family member may be considered medium urgency. Based on such categoization, the notification that is given to the user upon the occurrence of the event is determined. For example, if the user receives an email from a friend, the device 100 may vibrate twice, each vibration lasting one second. In another example, where the user receives an email from a family member, the device 100 may vibrate four times, each vibration lasting one second. This will be discussed in more, detail in reference to FIGS. 2-5.

In other implementation, another type of notification may be incorporated into the device 100. More specifically, the device 100 may provide a notification (different than the haptic or lighting patterns) for the event. For example, this notification may be an input from a user in response to the event detected. If the user receives a new email, the user may choose to click on the display to dismiss the notifications associated with the new email.

In one implementation, the priority settings defined by the various categories and the assignment of events to these categories may be defined within the factory settings of the device 100. In another implementation, such information may be provided by the user. The user may provide such information on the device 100 or through another device (e.g., device 150) that is connected to the device 100. When provided by the user, the information may be saved under a profile associated with the user. Further, the controller unit 120 may automatically apply the priority settings through manufacturing settings or by accessing that information through the user profile. In another implementation, the device 100 may ask the user to confirm the priority settings before applying. In such example, the device prompts the user to enter information regarding the settings. Such settings may be stored in the storage unit 130 connected to the controller unit 120.

The controller unit 120 may include a programmable logic controller, microprocessor, application specific integrated circuit, or the like having suitable programming code for performing the methods described herein. More specifically, the controller unit may be implemented using any suitable type of processing system where at least one processor executes computer-readable instructions stored in a memory. The processor may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium (e.g., the memory), or a combination thereof. The computer readable medium may be a non-transitory computer-readable medium that stores machine readable instructions, codes, data, and/or other information. The instructions, when executed by the processor (e.g., via one processing element or multiple processing elements of the processor) can cause the processor to perform processes described herein. The computer readable medium may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM).

The storage unit 130 storage units may include, but are not limited to, hard disk drives, compact disc drives, digital versatile disc drives, optical devices, and flash memory devices. In the present implementation, the storage unit 130 is shown in the device 100. In another implementation, the storage unit 130 may also be in the device 150, and the users data may be stored in the device 150. In a further implementation, the data may be stored in the cloud. Further, the data may be used to create a profile for the user associated with that data. For example, the user's priority settings may be saved under his profile. When the user logs into the device 100, the device may access the profile and perform analysis of the saved settings under that profile. In other examples, the user profile may include user data such as user preferences, additional settings, historical data, and/or alike. User preferences may include a user's schedule or calendar. User additional settings may include user's selection of a certain interface on the device. It should be noted that though a few examples are listed here for profile information, a user's profile may contain other types of data related to the user, general trends or the overall industry in addition to data related to location and time.

Further, the device 100 comprises the communications unit 140 such as a microphone 160, a speaker 170 units for audio input and output, a transmitter/receiver chip 180 that allows the controller unit 120 to communicate with the device 150 or another computing device (e.g., laptop, tablet). In some implementations, the controller unit 120 may send information to and/or receive from the device 150 through any suitable type of connection while still complying with the principles disclosed herein. For example, in some implementations, the device 100 is electrically coupled to the device 150 through an electric conductor, WI-FI, BLUETOOTH®, WiGig, an optical connection, an ultrasonic connection, or some combination thereof. Any suitable wireless (or wired electrical coupling) connection may be used between the device 100 and the device 150 such as, for example, WI-FI, BLUETOOTH®, ultrasonic, electrical cables, electrical leads, electrical spring-loaded pogo pins with magnetic holding force, or some combination thereof, while still complying with the principles disclosed herein.

In some implementations, a battery (not shown in FIG. 1) may be provided for powering the controller unit 120 and/or all the other components. In some embodiments, the battery may be rechargeable and/or replaceable. In one particular embodiment, the battery may be recharged via a USB connection (not shown in FIG. 1) that allows information to be transferred to another device such as a computer (not shown in FIG. 1).

In another implementation, the device 100 may comprise a sensor unit. The sensor unit may include any suitable sensor configured to measure one or more of but is not limited to, biometric data, temperature, and/or alike. In another implementation, more than one sensor unit may be provided. In one implementation, the sensor produces a data signal that is indicative of one or more parameters, such as biometric parameters, which may comprise, but not limited to, the user's heart rate, temperature and/or alike.

In one implementation, the device 100 may comprise a fastening band (not shown) for securing the device to a user. The fastening band of the device 100 is secured to a user with any suitable closures, such as Velcro, a buckle, a clasp, etc. However, a fastening band is not required and the device 100 can operate without a fastening band. Additionally, the device 100 can include other components, such as a GPS locator. The GPS locator allows users to keep track of the location of the device. It can also be used to keep track of the device users themselves. In different examples of the device 100, the device 100 may include buttons, such as a volume button to control audio feature, and a settings button to control the brightness/contrast of the display unit 110 and to customize features of the device 100.

The device 100 is communicatively connected to a second device 150. The device 150 may comprise any suitable device while still complying with the principles disclosed herein. For example, in some implementations, the device 150 may be a mobile phone, tablet, phablet or any other similar system containing a compute device. Further, the device 150 may have a permanent location in an environment (e.g., a room in a house). In other examples, the device 150 may be a portable device that is attached to the device 100 and that moves with the user. In either example, the device 100 maintains connection with the device 150. When the operation of the device 100 is initiated, the device 100 may confirm active connection with the device 150, identify an event, determine a category associated with the event and providing a series of notifications for the event, and these notifications are defined based on the category. In one example, some of the notifications may be presented on the display unit 110. In other implementations, the display unit may also be in the device 150. For example, a user of the device 100 may also use the display unit in the device 150 to interact with the device 100.

FIGS. 2-5 illustrate the device 100 in use, wherein a user is able to send and receive email messages, audio messages, and/or digital images, check email, check social networking sites, manage daily schedules and complete other functions. While performing those functions, the user is notified of all the events (e.g., incoming call, new email, new text message, and/or alike).

Referring now to FIG. 2, a table 200 listing the light and haptic notifications for different events in accordance with the principles disclosed herein is shown.

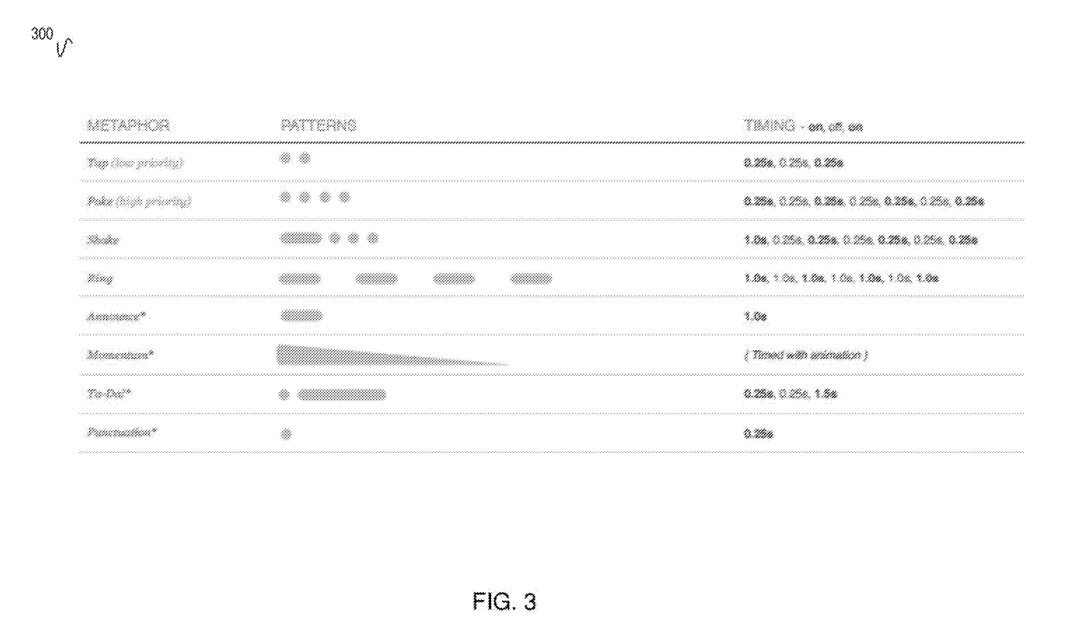

Referring now to FIG. 3, a table 300 providing more information related to the haptic notifications in accordance with the principles disclosed herein is shown. For example, a tap is defined to have a haptic pattern of two vibration, each lasting 0.25 seconds with a 0.25 seconds break in between. Similarly, a poke is defined to have a haptic pattern of four vibrations, each lasting 0.25 seconds with a 0.25 seconds break in between each vibration. Further, the table also defines a shake, ring, announce, momentum, to-da and punctuations.

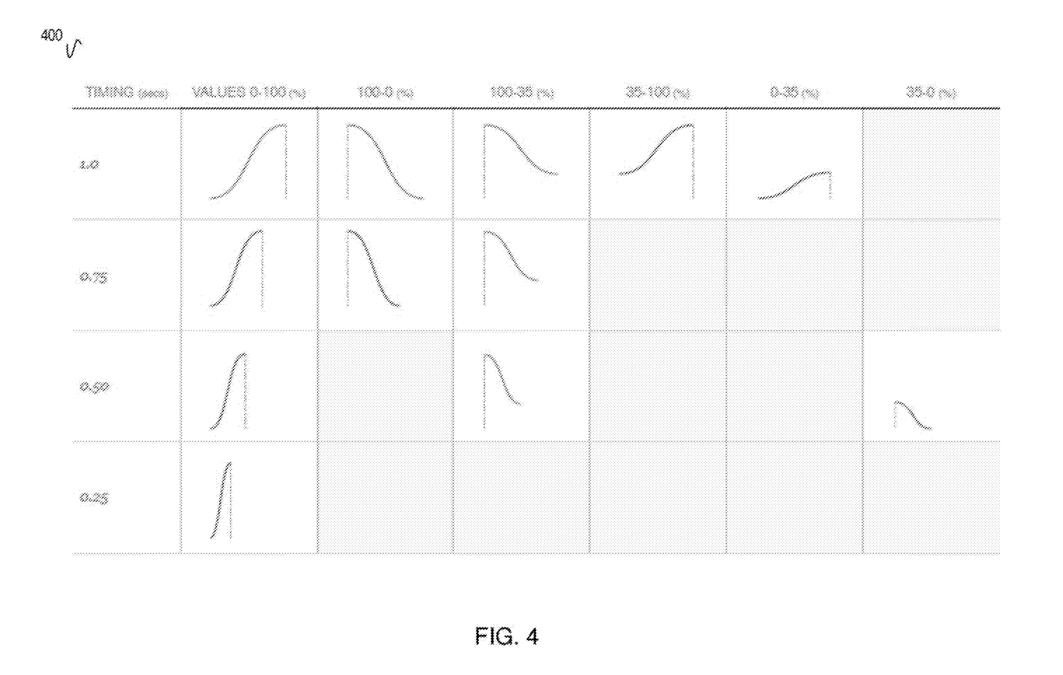

Referring now to FIG. 4, a table 400 providing more information related to the lighting notifications in accordance with the principles disclosed herein is shown. The table defines the lighting pulses based on time (how long the pulse lasts) and intensity chow the light changes during the pulse).

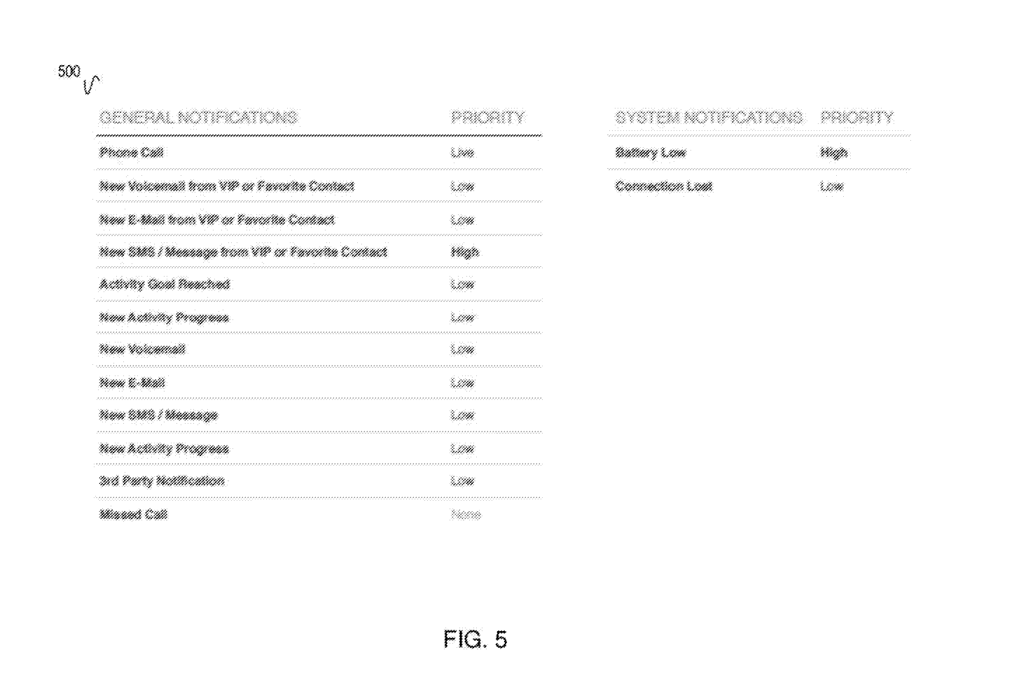

Referring now to FIG. 5, a table 500 providing more information related to the categories in accordance with the principles disclosed herein is shown. More specifically, the priority level for each notification is defined. For example, a new voicemail from a VIP or favorite contact is considered low priority/urgency. In another example, a new SMS message from a VIP or favorite contact is considered high priority.

It should be noted that in other implementations, the events, categories/priority settings, and notifications (haptic and lighting patterns) may be any suitable association for supporting the functionalities of the device 100 while still complying with the principles disclosed herein. Further, these can be remapped or redefined by the user (e.g., change the priority settings). Other examples may be provided while still complying with the principles disclosed herein.

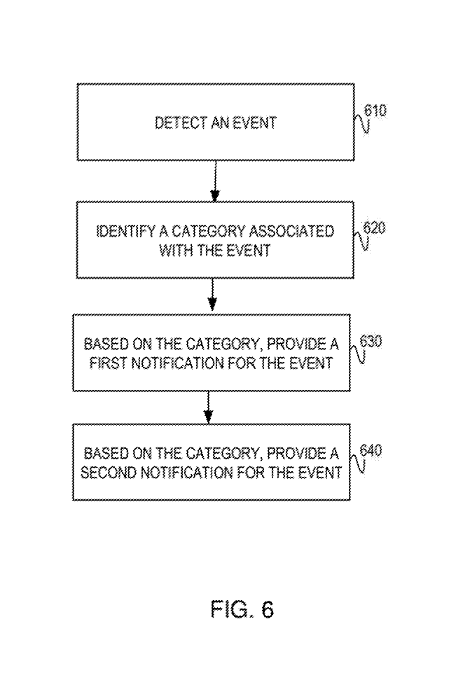

Referring now to FIG. 6, a flowchart of an example method executable by a system similar to the device 100 described in reference to FIGS. 1-5 is shown in accordance with the principles disclosed herein. At block 610, an event is detected. As discussed earlier, the event may comprise, but not limited to, an incoming call, a new email, a new text message, a calendar reminder, an update for reaching a goal, battery status, a mode change of the device (e.g., airplane mode on, airplane mode off, restart, factory reset) and/or alike. At block 620, a category associated with the event is determined. The category may be based on urgency (e.g., low urgency, medium urgency or high urgency), or based on a contact (e.g., family, friends, coworkers or unknown). For example, an email may be considered low urgency, while an SMS text message may be high urgency. The category assignments for different events can be predetermined (e.g., factory setting), or can be set by a user. At block 630, based on the category, the device provides a first notification for the event. The first notification is a haptic pattern. For example, if the user receives an email, the device may vibrate twice, each vibration lasting one second, whereas if the user receives a text message, the device may vibrate four times, each vibration lasting one second. At block 640, based on the category, the device provides a second notification for the event. The second notification is a lighting pattern. For example, if the user receives an email from a friend, the device may vibrate twice, each vibration lasting one second, whereas if the user receives an email from a family member, the device may vibrate four times, each vibration lasting one second.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system for providing notifications in a wearable device, comprising:
a controller unit to identify an event and determine a category associated with the event;
a vibration unit to provide a first notification for the event based on the category, wherein the first notification includes a haptic pattern; and
a display unit to provide a second notification for the event based on the category, wherein the second notification includes a lighting pattern.

2. The system of claim 1, further comprising a storage unit to store the user settings and preferences.

3. The system of claim 1, wherein the event comprises a new email, an incoming call, a new text message, a calendar invite and/or alike.

4. The system of claim 1, wherein the category comprises priority setting of low urgency, medium urgency or high urgency.

5. The system of claim 1, wherein the controller unit automatically selects a predetermined priority setting defined in the factory settings of the system for the category.

6. The system of claim 1, wherein the controller unit determines the category based on user input.

7. The system of claim 6, wherein the category is saved under a profile associated with the user.

8. The system of claim 1, wherein the display unit, controller unit, vibration unit and the communication unit are in a wearable device such as a watch, band, or alike.

9. The system of claim 1, wherein the second notification further comprises other information display mechanism.

10. A processor-implemented method of providing notifications in a wearable device, comprising:
identifying an event;
determining a category associated with the event;
providing a first notification for the event based on the category, wherein the first notification includes a haptic pattern; and
providing a second notification for the event based on the category, wherein the second notification includes a lighting pattern.

11. The method of claim 1, further comprising providing a third notification for the event, the third notification being an input from a user in response to the event.

12. The method of claim 1, further comprising creating a profile for a user, the profile comprising data related to user preferences and user settings.

13. The method of claim 1, wherein identifying the event comprises checking continuously for updates across applications in the device.

14. A non-transitory computer-readable medium comprising instructions which, when executed, cause a device to:
identify an event;
determine a category associated with the event;
provide a first notification for the event based on the category, wherein the first notification includes a haptic pattern;
provide a second notification for the event based on the category, wherein the second notification includes a lighting pattern; and
provide a third notification for the event, wherein the third notification is an input from a user in response to the first and second notifications.

15. The non-transitory computer-readable medium of claim 11, further comprising instructions further causing the device to apply the first and second notifications to systems attached to the device.
